(19) United States
(12) Patent Application Publication
(10) Pub. No.: US 2025/0389366 A1
(43) Pub. Date: Dec. 25, 2025

(54) LOW-INTERFERENCE AUTOMATIC DETECTION DEVICE AND DETECTION METHOD FOR DEFECTS AND CONDITIONS OF DRAINAGE PIPELINES

(71) Applicant: North China Municipal Engineering Design & Research Institute Co., LTD., Tianjin (CN)

(72) Inventors: Haozheng WANG, Tianjin (CN); Zhiyuan XIE, Tianjin (CN); Fansong WU, Tianjin (CN); Qiuyi WANG, Tianjin (CN); Liang ZHANG, Tianjin (CN); Shangjie WANG, Tianjin (CN)

(73) Assignee: North China Municipal Engineering Design & Research Institute Co., LTD., Tianjin (CN)

(21) Appl. No.: 19/317,581

(22) Filed: Sep. 3, 2025

Related U.S. Application Data
(63) Continuation of application No. PCT/CN2025/104698, filed on Jun. 27, 2025.

(30) Foreign Application Priority Data
Feb. 26, 2025 (CN) 202510212835.1

(51) Int. Cl. F16L 55/30; F16L 101/30

(52) U.S. Cl. CPC F16L 55/30; F16L 2101/30

(57) ABSTRACT

A low-interference automatic detection device includes an inspection detection system and two fixed detection systems. The fixed detection systems each include a semi-arc-shaped pipe wall fixing structure, a fixed detection transmission control system, and a plurality of first laser probes. The fixed detection transmission control system is installed on the pipe wall fixing structure. The plurality of first laser probes are respectively installed at different positions of the pipe wall fixing structure, and the plurality of first laser probes are connected to the fixed detection transmission control system. The inspection detection system includes an inspection track and an inspection robot. The inspection robot includes an inspection robot carrier, a robot controller, and a plurality of second laser probes. The plurality of second laser probes are respectively installed on a top and bottom of the inspection robot carrier. The inspection robot carrier is configured to move along the inspection track.

### CROSS-REFERENCE TO RELATED APPLICATIONS

This application is a continuation of International Patent Application No. PCT/CN2025/104698 with a filing date of Jun. 27, 2025, designating the United States, now pending, and further claims priority to Chinese Patent Application No. 202510212835.1 with a filing date of Feb. 26, 2025. The content of the aforementioned applications, including any intervening amendments thereto, is incorporated herein by reference.

### TECHNICAL FIELD

The present disclosure relates to the field of defect detection technology, and in particular, to a low-interference automatic detection device and detection method for defects and conditions of drainage pipelines.

### BACKGROUND

As an important infrastructure construction project in urban development, the drainage pipeline network system not only plays a significant role in collecting and transporting rainwater, urban domestic sewage, and industrial wastewater but also undertakes the important responsibilities of urban water environment pollution prevention, drainage, and flood control. However, due to long-term use, natural erosion, human destruction, and other factors, various defects may occur in drainage pipelines, such as collapse, blockage, deformation, and misalignment. These defects can not only affect the normal functions of the drainage pipelines but also cause serious issues such as environmental pollution, road waterlogging, and traffic inconvenience. Therefore, the detection of the defects in the drainage pipelines is particularly important.

The detection of the defects in the drainage pipelines involves extremely extensive aspects and requires the comprehensive use of multiple detection technologies and methods to ensure the normal operation of the drainage system and the flood control and drainage capacity of the city. The detection of the defects in the drainage pipelines mainly includes pipeline structural integrity detection and pipeline functional performance detection. The pipeline structural integrity detection mainly includes the detection of collapse and deformation, requires the locating and diagnosis of defect positions, and involves distance measurement, video measurement, and orientation positioning. The pipeline functional performance detection mainly includes the detection of blockage and sediments and involves the measurement of a distance, a sediment thickness, and a liquid level height. The detection of the defects in the drainage pipelines not only involves multiple detection targets but also poses great detection difficulty: The drainage pipeline system is distributed underground in the city and typically includes numerous branches, intersections, and branches, with strong concealment. This complex concealed network structure makes comprehensive detection extremely difficult. Municipal drainage pipelines are distributed throughout built-up areas of the city. Pipelines in some old urban areas are early constructed, have low standards, and are severely aged. There is perennial water flow in the drainage pipelines, causing large flow differences, high corrosiveness, and great detection difficulty.

In view of numerous detection targets and great technical difficulties in the detection of the defects in the drainage pipelines, a Closed Circuit Television (CCTV) detection technology, a sonar detection technology, an infrared thermal imaging technology, and a pipeline periscope detection technology are typically used in the industry at present, which can achieve pipeline defect detection under certain working conditions but have many deficiencies: the CCTV detection technology requires proper plugging, pumping, and cleaning of the pipeline before detection; in normal operation of the pipeline network, sludge and water flow greatly affect the movement of a CCTV detection robot, resulting in limited applicability; and the sonar detection technology generally can only detect the condition of the pipeline below the liquid level, making it difficult to detect defects above the liquid level. Some types of defects (such as pipeline deformation and blockage) may not be accurately identified. The infrared thermal imaging technology is greatly affected by the temperature, resulting in limited applicability. The pipeline periscope detection technology is mainly used for detecting short-distance pipelines, with simple operation but short detection distance, unable to detect the condition of the pipeline below the water surface. Therefore, the current drainage pipeline defect detection technology is difficult to efficiently solve the problems in the existing detection technologies, and a more applicable and effective detection technology needs to be developed.

### SUMMARY OF PRESENT INVENTION

The present disclosure is intended to solve at least one of the technical problems in related technologies to some extent.

In view of this, the present disclosure proposes a low-interference automatic detection device and detection method for defects and conditions of drainage pipelines, which can detect various defects during drainage of the drainage pipelines in normal operation and solve the problems in detection technologies of related technologies.

To achieve the above objective, an embodiment of a first aspect of the present disclosure proposes a low-interference automatic detection device for defects and conditions of drainage pipelines. The device includes an inspection detection system and two fixed detection systems, where the fixed detection systems each include a semi-arc-shaped pipe wall fixing structure, a fixed detection transmission control system, and a plurality of first laser probes; the fixed detection transmission control system is installed on the pipe wall fixing structure; the plurality of first laser probes are respectively installed at different positions of the pipe wall fixing structure, and the plurality of first laser probes are connected to the fixed detection transmission control system;
the inspection detection system includes an inspection track and an inspection robot, where the inspection robot includes an inspection robot carrier, a robot controller, a plurality of second laser probes, and a cleaning device; the robot controller is connected to the inspection robot carrier, the plurality of second laser probes, and the cleaning device through an integrated cable; the plurality of second laser probes are respectively installed on a top and bottom of the inspection robot carrier; the cleaning device is installed on the inspection robot carrier; and
during detection, the inspection track passes through a drainage pipeline, the two fixed detection systems are respectively disposed at both ends of the inspection track and located on an upper surface of the inspection track, and the inspection robot carrier is configured to move along a lower surface of the inspection track in a suspended manner.

In some implementations, the pipe wall fixing structure is formed by sequentially connecting a plurality of arc-shaped detection system pipe wall fixing bands; adjacent detection system pipe wall fixing bands are connected through fixing band rotation shafts; the detection system pipe wall fixing band is provided with a fixing band fastening hole; and the fixed detection transmission control system or the pipe wall fixing structure is provided with a fixed detection system fixing rod for fixing the fixed detection system to the drainage pipeline.

In some implementations, the plurality of first laser probes include three first laser probes; the three first laser probes are respectively located at both ends and a middle position of the pipe wall fixing structure; and
connection ends of the plurality of first laser probes are each provided with a laser probe rotation shaft; a tail end of the laser probe rotation shaft is provided with a laser probe fixing clasp; and after a position of the first laser probe is determined, the position is locked by rotating the laser probe fixing clasp.

In some implementations, both ends of the inspection track are bent upward to form U-shaped parts, and upper portions of the two U-shaped parts are respectively used as a head end and tail end of the inspection track; the head end and tail end of the inspection track are each provided with an inspection track locator; the inspection robot carrier is configured to locate a docking position and a traveling direction on the inspection track through the inspection track locator; a width of each of the head end and tail end of the inspection track is set to increase from small to large, allowing for smooth docking of the inspection robot carrier onto the inspection track; and
during detection, the inspection track is fixed to both the ground and a top of the drainage pipeline respectively through an inspection track top fixing rod and an inspection track bottom fixing rod.

In some implementations, the inspection robot further includes transmission wheels, transmission wheel motors, a withdrawable motor cabinet, inspection positioning detectors, tires, and tire drive motors that are installed on the inspection robot carrier; four transmission wheels are disposed at the top of the inspection robot carrier, and the four transmission wheels are all driven by the transmission wheel motors; side surfaces of the transmission wheels are concave and are configured to be engaged with the inspection track; two transmission wheel motors corresponding to one side of the inspection track are fixed to the withdrawable motor cabinet through motor bases; a front end of the withdrawable motor cabinet is provided with a withdrawable cabinet latch, and a bottom or side surface of the withdrawable motor cabinet is provided with a snap-fitted structure; the snap-fitted structure is able to be locked with or disengaged from a slot structure on the inspection robot carrier by pulling or pushing the withdrawable cabinet latch; during disengagement, the two transmission wheels on the withdrawable motor cabinet are configured to move along transmission wheel movement grooves on the top of the inspection robot carrier to one side disengaging from the inspection track, achieving the disengagement of the inspection robot carrier from the inspection track; and two tires at a front end of the inspection robot carrier are driven by the tire drive motors.

In some implementations, the low-interference automatic detection device for defects and conditions of drainage pipelines further includes two U-shaped longitudinal inspection tracks; the two longitudinal inspection tracks are located on inner sides of the two U-shaped parts of the inspection track; both ends of the inspection track are respectively connected to the two longitudinal inspection tracks, and middle portions of the longitudinal inspection tracks are fixed to middle portions of the U-shaped parts through inspection track connecting rods; outer sides of the longitudinal inspection tracks are provided with gear holes;
transmission wheel secondary gears are installed at tops of the transmission wheels; the transmission wheel secondary gears are configured to be engaged with the gear holes of the longitudinal inspection tracks; both sides of the top of the inspection robot carrier are each provided with a semi-enclosed engagement plate; the engagement plate has elasticity; and a side of the engagement plate in contact with the inspection track is provided with an engagement plate planar ball and an engagement plate vertical ball; and
during detection, the longitudinal inspection tracks are fixed to a side wall of a pipeline outlet through longitudinal inspection track fixing rods.

In some implementations, the cleaning device includes a cleaning shovel; a tail end of the cleaning shovel is connected to the inspection robot carrier through a cleaning shovel rotation shaft; a front end of the cleaning shovel is located at the top of the inspection robot carrier and is engaged with the inspection track during inspection; the cleaning shovel is V-shaped; a bent portion of the V-shaped cleaning shovel is wider than both ends of the V-shaped cleaning shovel; upper and lower parts inside the cleaning shovel are respectively provided with a top cleaning sponge and a bottom cleaning sponge; and the front end of the cleaning shovel is provided with a hard rubber shell.

In some implementations, the inspection robot further includes a video camera and a lighting lamp; the video camera is connected to a video camera rotation disk through video camera swing shafts connected to both sides of the video camera; the video camera rotation disk is fixed to the front end of the inspection robot carrier; a lens brush is disposed beside the video camera; the lighting lamp is fixed to the front end of the inspection robot carrier; and the robot controller is connected to the video camera and the lighting lamp through the integrated cable.

In some implementations, the cleaning device includes a high-pressure water jet nozzle, where the high-pressure water jet nozzle is connected to a high-pressure water jet nozzle rotation disk through high-pressure water jet nozzle swing shafts connected to both sides of the high-pressure water jet nozzle, and the high-pressure water jet nozzle rotation disk is fixed to the front end of the inspection robot carrier.

In some implementations, the low-interference automatic detection device for defects and conditions of drainage pipelines further includes a track installation structure for installing the inspection track; the track installation structure includes a float ball, a float ball cable, and a float ball cable storage device; a tail end of the float ball is connected to the float ball cable; a tail end of the float ball cable is connected to the float ball cable storage device; and
during the installation of the inspection track, one end of the inspection track is connected to the float ball cable; the float ball is placed in water of the drainage pipeline through a first inspection well; after the float ball reaches a next inspection well with water flow, the float ball is taken out, and the float ball cable is pulled until the inspection track passes through the drainage pipeline to reach a preset position; and both ends of the inspection track are fixed to the ground and the drainage pipeline.

To achieve the above objective, an embodiment of a second aspect of the present disclosure proposes an automatic detection method for defects and conditions of drainage pipelines, where the automatic detection method for defects and conditions of drainage pipelines is implemented by the low-interference automatic detection device for defects and conditions of drainage pipelines according to the first aspect; the two fixed detection systems are a first fixed detection system and a second fixed detection system respectively; and the automatic detection method for defects and conditions of drainage pipelines includes:
activating a plurality of first laser probes of the two fixed detection systems, detecting whether each first laser probe of the first fixed detection system receives laser emitted by a corresponding first laser probe of the second fixed detection system, and detecting whether each first laser probe of the second fixed detection system receives laser emitted by a corresponding first laser probe of the first fixed detection system;
in a case that a first target laser probe in the plurality of first laser probes of the first fixed detection system fails to receive laser emitted by a corresponding first laser probe of the second fixed detection system, acquiring position information of a structural defect of the drainage pipeline based on a laser emission time, laser return time, and laser transmission speed of the first target laser probe;
in a case that a second target laser probe in the plurality of first laser probes of the second fixed detection system fails to receive laser emitted by a corresponding first laser probe of the first fixed detection system, acquiring position information of a structural defect of the drainage pipeline based on a laser emission time, laser return time, and laser transmission speed of the second target laser probe; and
activating the inspection detection system; driving the inspection robot carrier to dock with the inspection track and travel along the inspection track; acquiring, by the second laser probe at a specified time frequency during the traveling process, a first distance from the top of the inspection robot carrier to the top of the drainage pipeline and a second distance from the bottom of the inspection robot carrier to a bottom liquid level or bottom sludge level of the drainage pipeline or the bottom of the pipeline, and acquiring information of a sludge level or liquid level of a corresponding position of the drainage pipeline based on the first distance, the second distance, and parameters of the drainage pipeline; and detecting a position corresponding to position information based on the position information of the structural defect in the drainage pipeline.

The present disclosure has the following beneficial effects:

According to the low-interference automatic detection device and detection method for defects and conditions of drainage pipelines provided in the present disclosure, the two fixed detection systems can be configured to detect whether there are structural defects in the pipeline, and the inspection detection system can be configured to acquire information such as the liquid level and sludge thickness in the pipeline, achieving detection of blockage and sediments of the pipeline, thereby achieving automatic inspection and exploration in a drainage pipeline network. The inspection detection system performs pipeline inspection through the inspection robot carrier moving along the lower surface of the inspection track in a suspended manner, without the need to intercept and clean a target pipeline, achieving inspection detection during drainage of the drainage pipeline in normal operation, thereby effectively avoiding the situation where a conventional inspection robot is difficult to operate in a muddy water environment. Furthermore, both fixed detection and inspection detection modes are used for exploration of the defects in the pipeline. After structural abnormalities are found and positions of structural defects in the pipeline are locked through fixed detection, the inspection detection system can further detect the positions determined by the fixed detection systems, avoiding misjudgments of the fixed detection systems caused by interference from garbage in the drainage pipeline. The dual detection modes can accurately locate the positions of the structural defects in the pipeline, with an extremely low misjudgment rate. The automatic detection device of the present disclosure has a high degree of automation and intelligence, can reduce a lot of labor and time costs, has high inspection and exploration efficiency, reduces the cost of pipeline cleaning, and has no influence on the normal operation of the drainage pipeline.

For additional aspects and advantages of the present disclosure, some will be given in the following description, and some will become apparent in the following description or will be understood in the practice of the present disclosure.

### BRIEF DESCRIPTION OF THE DRAWINGS

The above and/or additional aspects and advantages of the present disclosure will become obvious and easy to understand from the description of the embodiments with reference to the following drawings.

FIG. 1 is a schematic structural diagram of a low-interference automatic detection device for defects and conditions of drainage pipelines according to an embodiment of the present disclosure;

FIG. 2 is a schematic structural diagram of a fixed detection system according to an embodiment of the present disclosure;

FIG. 3 is a schematic structural diagram of an inspection track according to an embodiment of the present disclosure;

FIG. 4 is a schematic structural diagram of an inspection robot according to an embodiment of the present disclosure;

FIG. 5 is a schematic structural diagram of connection of tires at a front end of an inspection robot carrier according to an embodiment of the present disclosure; and

FIG. 6 is a schematic structural diagram of a track installation structure according to an embodiment of the present disclosure.

In the drawings:
100. fixed detection system; 200. inspection detection system; 1. fixed detection system fixing rod; 2. fixed detection transmission control system; 3. fixed detection system battery; 4. first top laser probe; 5. first top laser signal receiver; 6. first top laser signal transmitter; 7. detection system pipe wall fixing band; 8. fixing band rotation shaft; 9. fixing band fastening hole; 10. laser probe fixing clasp; 11. laser probe rotation shaft; 12. first bottom laser probe; 13. inspection robot carrier; 14. tire; 15. transmission wheel secondary gear; 16. transmission wheel; 17. engagement plate; 18. engagement plate planar ball; 19. engagement plate vertical ball; 20. second top laser probe; 21. top cleaning sponge; 22. cleaning shovel rotation shaft; 23. bottom cleaning sponge; 24. cleaning shovel; 25. integrated cable; 26. heat dissipation hole; 27. withdrawable motor cabinet; 28. transmission wheel movement groove; 29. withdrawable cabinet latch; 30. transmission wheel motor; 31. motor base; 32. second bottom laser probe; 33. video camera rotation disk; 34. video camera swing shaft; 35. lens brush; 36. video camera; 37. lighting lamp; 38. inspection positioning detector; 39. high-pressure water jet nozzle rotation disk; 40. high-pressure water jet nozzle swing shaft; 41. high-pressure water jet nozzle; 42. integrated cable storage device; 43. inspection track locator; 44. inspection track; 45. inspection track top fixing rod; 46. longitudinal inspection track; 47. longitudinal inspection track fixing rod; 48. inspection track connecting rod; 49. inspection track bottom fixing rod; 50. float ball; 51. float ball cable; 52. float ball cable storage device; 53. pipeline outlet; 54. road profile; and 55. sludge.

### DETAILED DESCRIPTION OF THE EMBODIMENTS

The embodiments of the present disclosure are described in detail below. Examples of the embodiments are shown in the accompanying drawings, and the same or similar reference signs indicate the same or similar components or components with the same or similar functions. The embodiments described below with reference to the accompanying drawings are illustrative, are intended to explain the present disclosure, and should not be construed as limitations on the present disclosure.

A low-interference automatic detection device for defects and conditions of drainage pipelines according to an embodiment of the present disclosure is described below with reference to the drawings.

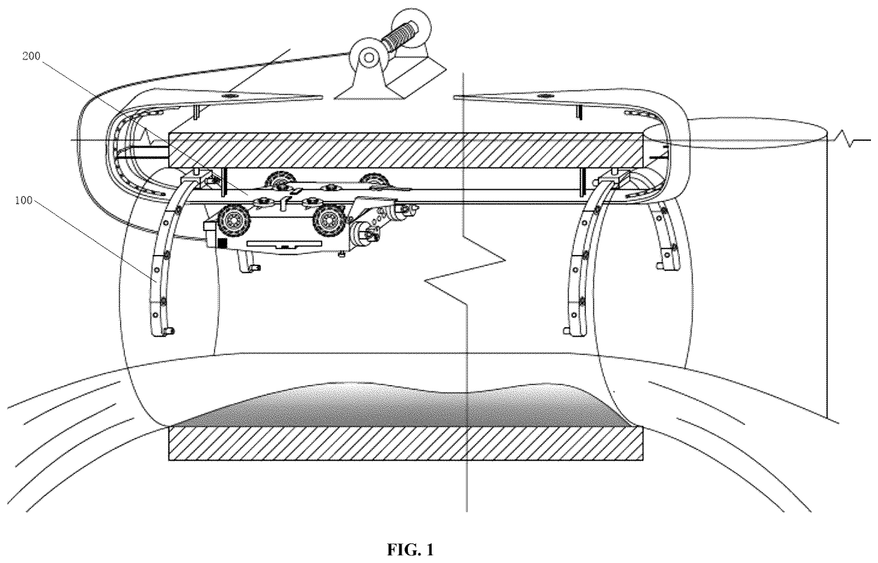

FIG. 1 is a schematic structural diagram of a low-interference automatic detection device for defects and conditions of drainage pipelines according to an embodiment of the present disclosure. As shown in FIG. 1, the low-interference automatic detection device for defects and conditions of drainage pipelines may include: an inspection detection system 200 and two fixed detection systems 100.

The fixed detection systems 100 each include a semi-arc-shaped pipe wall fixing structure, a fixed detection transmission control system 2, and a plurality of first laser probes. The fixed detection transmission control system 2 is installed on the pipe wall fixing structure. The plurality of first laser probes are respectively installed at different positions of the pipe wall fixing structure, and the plurality of first laser probes are connected to the fixed detection transmission control system 2. Optionally, the plurality of first laser probes include one first top laser probe 4 and two first bottom laser probes 12 that are respectively located at a middle position and both sides of the pipe wall fixing structure.

The inspection detection system 200 includes an inspection track 44 and an inspection robot, where the inspection robot includes an inspection robot carrier 13, a robot controller, a plurality of second laser probes, and a cleaning device. The robot controller is connected to the inspection robot carrier 13, the plurality of second laser probes, and the cleaning device through an integrated cable 25. The plurality of second laser probes are respectively installed on a top and bottom of the inspection robot carrier 13. The cleaning device is installed on the inspection robot carrier 13.

During detection, the inspection track 44 passes through the drainage pipeline, the two fixed detection systems 100 are respectively disposed at both ends of the inspection track 44 and located on an upper surface of the inspection track 44, and the inspection robot carrier 13 is configured to move along a lower surface of the inspection track 44 in a suspended manner.

During installation, the two fixed detection systems 100 are respectively disposed at both ends of the drainage pipeline, the inspection track 44 passes through the drainage pipeline, the inspection robot carrier 13 is configured to move along the lower surface of the inspection track 44 in a suspended manner, and the two fixed detection systems 100 are located on the upper surface of the inspection track 44. This causes no influence on the movement of the inspection robot carrier 13 on the inspection track 44. Both ends of the inspection track 44 extend to the ground of both ends of the drainage pipeline or a side wall of the drainage pipeline.

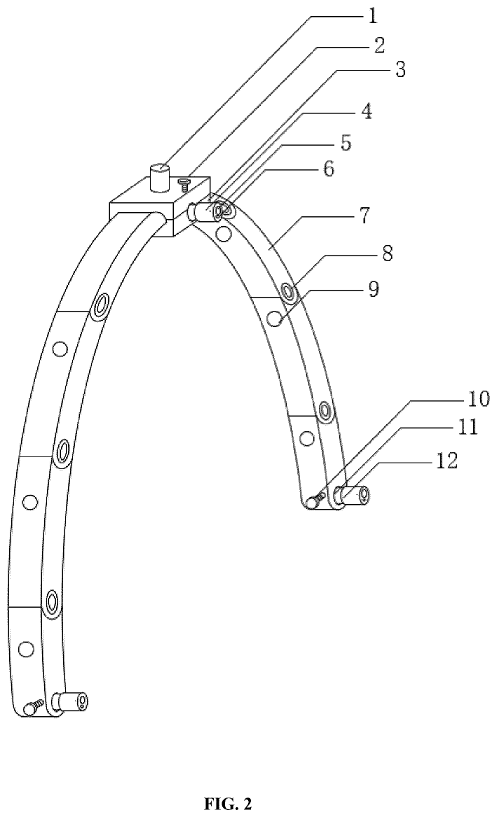

It should be noted that the first laser probes and the second laser probes each include a laser signal transmitter and a laser signal receiver and are able to transmit and receive laser signals. For example, as shown in FIG. 2, the first top laser probe 4 includes a first top laser signal receiver 5 and a first top laser signal transmitter 6.

It should be further noted that the principle of detecting whether there are structural defects in the drainage pipeline through the first laser probes is the linear propagation of the laser. When the laser is obstructed on a propagation path, the two fixed detection systems located at both ends of the drainage pipeline are unable to receive laser signals from each other, so it is determined that the drainage pipeline is highly likely to have structural defects. Laser signals returned at positions where the propagation is obstructed return to the laser signal receivers of the original first laser probes; and positions of structural defects can be calculated based on a known laser propagation speed and round-trip propagation time.

Thus, the fixed detection transmission control system 2 controls the activation and deactivation of the first laser probes. For example, the first top laser probe 4 located at the middle position of the pipe wall fixing structure can be configured to detect whether there are structural defects on the top of the drainage pipeline. The first bottom laser probes 12 located at both ends of the bottom of the pipe wall fixing structure can be configured to detect whether there are structural defects on the side wall of the drainage pipeline, such as collapse and deformation. When one laser signal is obstructed, a position of a structural defect is calculated based on transmission time and return time of the laser signal as well as a laser transmission velocity, and acquired and computed data is transmitted to a user platform system.

Thus, a distance from the top of the inspection robot carrier 13 to the top of the drainage pipeline can be measured by the inspection detection system 200 and a second laser probe (a second top laser probe 20) at the top of the inspection robot carrier 13. A distance from the bottom of the inspection robot carrier 13 to a liquid level, a sludge level, or the bottom of the pipeline can be measured by a second laser probe (a second bottom laser probe 32) at the bottom of the inspection robot carrier 13. Since laser probe parameters can be obtained based on the design of equipment and the specifications of the drainage pipeline are known, information such as the liquid level and the thickness of sludge 55 of the drainage pipeline can be calculated.

According to the low-interference automatic detection device for defects and conditions of drainage pipelines provided by this embodiment of the present disclosure, the two fixed detection systems 100 can be configured to detect whether there are structural defects in the pipeline, and the inspection detection system 200 can be configured to acquire information such as the liquid level and sludge thickness in the pipeline, achieving detection of blockage and sediments of the pipeline, thereby achieving automatic inspection and exploration in a drainage pipeline network. The inspection detection system 200 performs pipeline inspection through the inspection robot carrier 13 moving along the lower surface of the inspection track 44 in a suspended manner, without the need to intercept and clean a target pipeline, achieving inspection detection during drainage of the drainage pipeline in normal operation, thereby effectively avoiding the situation where a conventional inspection robot is difficult to operate in a muddy water environment. Furthermore, both fixed detection and inspection detection modes are used for exploration of the defects in the pipeline. After structural abnormalities are found and positions of structural defects in the pipeline are locked through fixed detection, the inspection detection system 200 can further detect the positions determined by the fixed detection systems 100, avoiding misjudgments of the fixed detection systems caused by interference from garbage in the drainage pipeline. The dual detection modes can accurately locate the positions of the structural defects in the pipeline, with an extremely low misjudgment rate. The automatic detection device of the present disclosure has a high degree of automation and intelligence, can reduce a lot of labor and time costs, has high inspection and exploration efficiency, reduces the cost of pipeline cleaning, and has no influence on the normal operation of the drainage pipeline.

In some embodiments, as shown in FIG. 2, the pipe wall fixing structure is formed by sequentially connecting a plurality of arc-shaped detection system pipe wall fixing bands 7. Adjacent detection system pipe wall fixing bands 7 are connected through fixing band rotation shafts 8. The detection system pipe wall fixing band 7 is provided with a fixing band fastening hole 9. The fixed detection transmission control system 2 or the pipe wall fixing structure is provided with a fixed detection system fixing rod 1 for fixing the fixed detection system 100 to the drainage pipeline.

Thus, the pipe wall fixing structure can adjust its curvature according to pipe diameter specifications of different drainage pipelines, ensuring tight contact with pipe walls of the drainage pipelines. The detection system pipe wall fixing band 7 can be fixed to the pipe wall of the drainage pipeline through a bolt passing through the fixing band fastening hole 9. The fixed detection system 100 can be fixed to the top of the drainage pipeline through the fixed detection system fixing rod 1.

In some embodiments, the plurality of first laser probes include three first laser probes. The three first laser probes are respectively located at both ends and a middle position of the pipe wall fixing structure. Connection ends of the plurality of first laser probes are each provided with a laser probe rotation shaft 11. A tail end of the laser probe rotation shaft 11 is provided with a laser probe fixing clasp 10. After a position of the first laser probe is determined, the position is locked by rotating the laser probe fixing clasp 10.

Thus, the connection ends of the plurality of first laser probes can each rotate flexibly through the laser probe rotation shaft 11. Through the laser probe fixing clasp 10 at the tail end of the laser probe rotation shaft 11, the position of the first laser probe can be locked by rotating the laser probe fixing clasp 10 after the position of the first laser probe is determined.

In some embodiments, the fixed detection transmission control system 2 is connected to a fixed detection system battery 3. The fixed detection system battery 3 may supply energy to the fixed detection system 100.

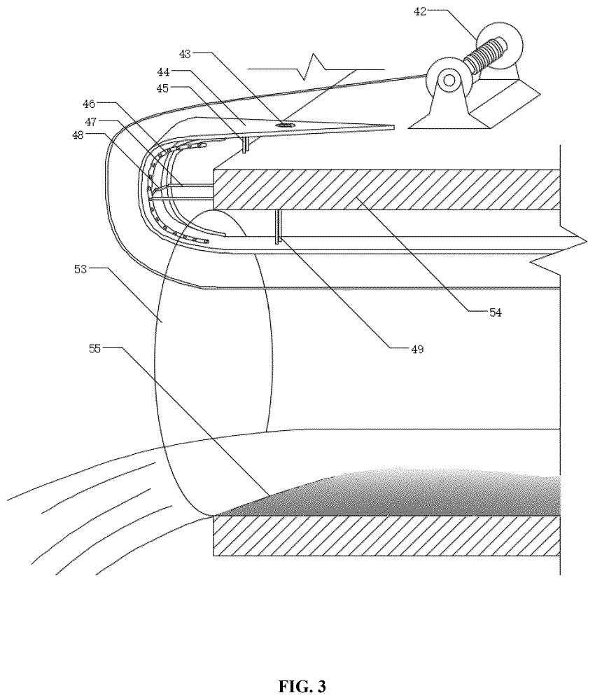

In some implementations, as shown in FIG. 3, both ends of the inspection track 44 are bent upward to form U-shaped parts. Upper portions of the two U-shaped parts are respectively used as a head end and tail end of the inspection track 44. The head end and tail end of the inspection track 44 are each provided with an inspection track locator 43. The inspection robot carrier 13 is configured to locate a docking position and a traveling direction on the inspection track 44 through the inspection track locator 43. A width of each of the head end and tail end of the inspection track 44 is set to increase from small to large, allowing for smooth docking of the inspection robot carrier 13 onto the inspection track 44. During detection, the inspection track 44 is fixed to both the ground and a top of the drainage pipeline respectively through an inspection track top fixing rod 45 and an inspection track bottom fixing rod 49, that is, the inspection track 44 is fixed to a road profile 54 in FIG. 3. Thus, the inspection robot carrier 13 can locate the docking position and the traveling direction on the inspection track 44 through the inspection track locator 43.

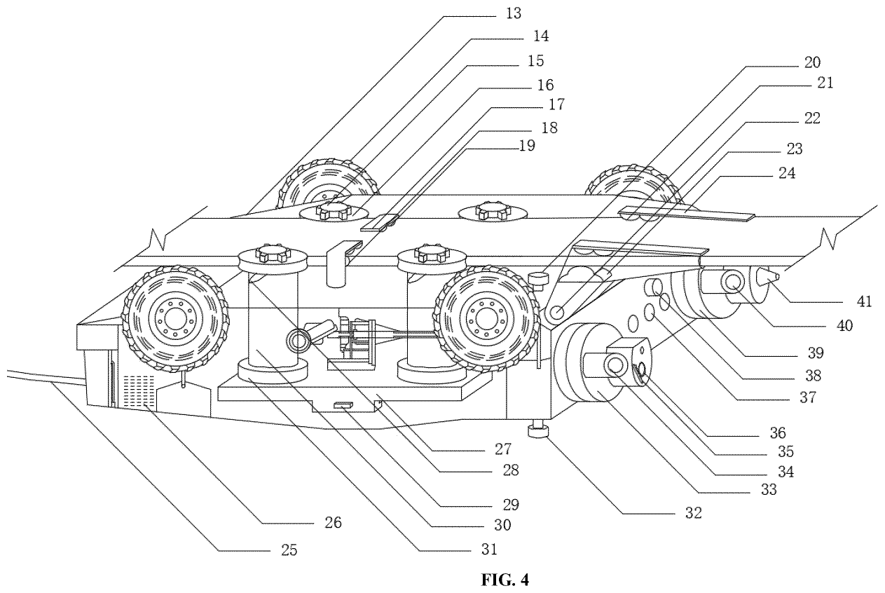

In some embodiments, as shown in FIG. 4, the inspection robot further includes transmission wheels 16, transmission wheel motors 30, a withdrawable motor cabinet 27, and an inspection positioning detector 38 that are installed on the inspection robot carrier 13. Four transmission wheels 16 are disposed at the top of the inspection robot carrier 13. The four transmission wheels 16 are all driven by the transmission wheel motors 30. Side surfaces of the transmission wheels 16 are concave and are configured to be engaged with the inspection track 44. Two transmission wheel motors 30 corresponding to one side of the inspection track 44 are fixed to the withdrawable motor cabinet 27 through motor bases 31. A front end of the withdrawable motor cabinet 27 is provided with a withdrawable cabinet latch 29. A bottom or side surface of the withdrawable motor cabinet 27 is provided with a snap-fitted structure. The snap-fitted structure is able to be locked with or disengaged from a slot structure on the inspection robot carrier 13 by pulling or pushing the withdrawable cabinet latch 29. During disengagement, the two transmission wheels 16 on the withdrawable motor cabinet 27 are configured to move along transmission wheel movement grooves 28 on the top of the inspection robot carrier 13 to one side disengaging from the inspection track 44, achieving the disengagement of the inspection robot carrier 13 from the inspection track 44.

The withdrawable motor cabinet 27 can be inserted into or pulled out relative to the inspection robot carrier 13. When the withdrawable motor cabinet 27 is pushed to a target position of the inspection robot carrier 13, that is, a position where the transmission wheels 16 are engaged with the inspection track 44, the withdrawable motor cabinet 27 and the inspection robot carrier 13 can be limited by the snap-fitted structure. When the withdrawable motor cabinet 27 is pulled by the withdrawable cabinet latch 29 in a short distance, the inspection robot carrier 13 can be disengaged from the inspection track 44.

The snap-fitted structure may be a flexible structure. The flexible structure can deform when the withdrawable motor cabinet 27 is inserted into or pulled out of the inspection robot carrier 13. When reaching a target position, the flexible structure is clamped into a corresponding slot structure on the inspection robot carrier 13.

In other words, the transmission wheel motors 30 are disposed in the inspection robot carrier 13 and are respectively connected to the transmission wheels 16. Bottoms of the transmission wheel motors 30 are each provided with a motor base 31 and can be fixed. Two motor bases 31 are fixed to the withdrawable motor cabinet 27. The withdrawable motor cabinet 27 is provided with the withdrawable cabinet latch 29. The top of inspection robot carrier 13 is provided with the transmission wheel movement grooves 28. The transmission wheels 16 and the transmission wheel motors 30 can move transversely by pulling the withdrawable cabinet latch 29, thereby achieving the disengagement of the inspection robot carrier 13 from the inspection track 44.

Thus, the inspection robot carrier 13 can detect the inspection track locator 43 on the inspection track 44 through the inspection positioning detector 38 at the front end, the inspection robot carrier 13 is guided to automatically dock with the inspection track 44, and a start point and end point of the inspection track 44 are automatically identified. The inspection robot carrier 13 is in an inverted suspended state after entering the drainage pipeline. The inspection robot carrier 13 can be engaged with the inspection track 44 through concave shapes of side surfaces of the transmission wheels 16 at the top.

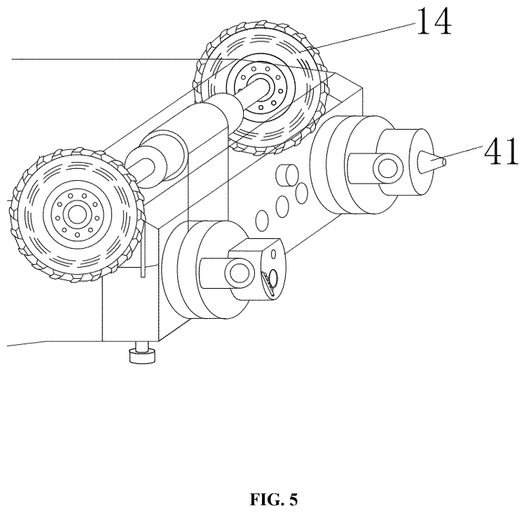

In some embodiments, the inspection robot carrier 13 is provided with four tires 14. As shown in FIG. 5, two tires 14, located at the front end of the inspection robot carrier 13, in the four tires 14 are driven by tire drive motors to run on the ground. When both ends of the inspection track 44 are fixed to the ground, they need to be elevated to a certain height above the surface. This allows the inspection robot carrier 13 to automatically dock with the inspection track 44 from a road traveling mode and enter a suspended inspection mode inside the drainage pipeline. In other words, after the inspection robot carrier 13 moves on the ground through the tires 14 to a position of the inspection track locator 43, the inspection robot carrier 13 is engaged with the inspection track 44 through the concave shapes of the side surfaces of the transmission wheels 16 at the top. The robot controller controls the tire drive motors that drive the tires 14 to stop operating and controls the transmission wheel motors 30 to start operating so as to drive the inspection robot carrier 13 to perform an inspection task along the inspection track 44.

In some embodiments, as shown in FIG. 3 and FIG. 4, the low-interference automatic detection device for defects and conditions of drainage pipelines further includes two U-shaped longitudinal inspection tracks 46. The two longitudinal inspection tracks 46 are located on inner sides of the two U-shaped parts of the inspection track 44. Both ends of the inspection track 44 are respectively connected to the two longitudinal inspection tracks 46. Middle portions of the longitudinal inspection tracks 46 are fixed to middle portions of the U-shaped parts through inspection track connecting rods 48. Outer sides of the longitudinal inspection tracks 46 are provided with gear holes. Transmission wheel secondary gears 15 are installed at tops of the transmission wheels 16. The transmission wheel secondary gears 15 are configured to be engaged with the gear holes of the longitudinal inspection tracks 46. Both sides of the top of the inspection robot carrier 13 are each provided with a semi-enclosed engagement plate 17. The engagement plate 17 has certain elasticity. A side of the engagement plate 17 in contact with the inspection track 44 is provided with an engagement plate planar ball 18 and an engagement plate vertical ball 19. During detection, the longitudinal inspection tracks 46 are fixed to a side wall of a pipeline outlet 53 through longitudinal inspection track fixing rods 47.

As one implementation, tail ends of the longitudinal inspection track fixing rods 47 are fixed to the side wall of the pipeline outlet 53. Start ends of the longitudinal inspection track fixing rods 47 are connected to the longitudinal inspection tracks 46. The longitudinal inspection tracks 46 are fixed to a vertical section of the inspection track 44 through inspection track connecting rods 48. Two inspection track connecting rods 48 are fixed to the inspection track 44 at one point.

Thus, the secondary transmission gears 15 may be engaged with the longitudinal inspection tracks 46, so that a higher climbing capability can be provided for the inspection robot carrier 13 in a vertical movement state. The inspection robot carrier 13 cooperates with the inspection track 44 through two semi-enclosed engagement plates 17 at the top, so that a suspension force can be provided for the movement of the inspection robot carrier 13.

In some embodiments, as shown in FIG. 4, the cleaning device includes a cleaning shovel 24. A tail end of the cleaning shovel 24 is connected to the inspection robot carrier 13 through a cleaning shovel rotation shaft 22. A front end of the cleaning shovel 24 is located at the top of the inspection robot carrier 13 and is engaged with the inspection track 44 during inspection. The cleaning shovel 24 is V-shaped. A bent portion of the V-shaped cleaning shovel is wider than both ends of the V-shaped cleaning shovel. Upper and lower parts inside the cleaning shovel 24 are respectively provided with a top cleaning sponge 21 and a bottom cleaning sponge 23. The front end of the cleaning shovel 24 is provided with a hard rubber shell.

Thus, one end of the cleaning shovel 24 is engaged with the inspection track 44, so that solid obstruction and interference substances attached to the inspection track 44 can be removed, achieving the preliminary cleaning of the track. The top cleaning sponge 21 and bottom cleaning sponge 23 respectively disposed at the upper and lower parts inside the cleaning shovel 24 can perform further cleaning of the inspection track 44, so that the debris interference on the inspection track 44 can be effectively eliminated, ensuring normal inspection operation with high reliability and broad applicability.

In some embodiments, as shown in FIG. 4, the inspection robot further includes a video camera 36 and a lighting lamp 37. The video camera is connected to a video camera rotation disk 33 through video camera swing shafts 34 connected to both sides of the video camera 36. The video camera rotation disk 33 is fixed to the front end of the inspection robot carrier 13. A lens brush 35 is disposed beside the video camera 36. The lighting lamp 37 is fixed to the front end of the inspection robot carrier 13. The robot controller is connected to the video camera 36 and the lighting lamp 37 through the integrated cable 25.

Thus, the inspection robot carrier 13 can acquire high-definition video information inside the drainage pipeline through the video camera 36 disposed on one side of the front end. After the fixed detection system 100 determines positions with collapse or deformation, video information of defect positions can be acquired at close range. Diagnostic evidence for pipeline defects is provided. Misjudgment caused by debris interference in the fixed detection mode is further avoided. The dual detection modes can accurately locate the positions with collapse, fractures, or deformation in the pipeline, with an extremely low misjudgment rate.

In some embodiments, as shown in FIG. 4, the cleaning device includes a high-pressure water jet nozzle 41. The high-pressure water jet nozzle 41 is connected to a high-pressure water jet nozzle rotation disk 39 through high-pressure water jet nozzle swing shafts 40 connected to both sides of the high-pressure water jet nozzle 41. The high-pressure water jet nozzle rotation disk 39 is fixed to the front end of the inspection robot carrier 13.

Thus, the high-pressure water jet nozzle 41 can swing up and down through the high-pressure water jet nozzle swing shafts 40 connected to both sides of the high-pressure water jet nozzle 41. Other ends of the high-pressure water jet nozzle swing shafts 40 are fixed to the high-pressure water jet nozzle rotation disk 39, allowing the high-pressure water jet nozzle 41 to rotate. Therefore, an angle of the high-pressure water jet nozzle 41 can be adjusted to rapidly remove interference substances on the inspection track 44 and blockages inside the pipeline.

In some embodiments, the integrated cable 25 is disposed at the rear of the inspection robot carrier 13. A plurality of conduits are disposed in the integrated cable 25 for transmitting power and control signals and water supply. A tail end of the integrated cable 25 is connected to a cable storage device 42. Side walls of the inspection robot carrier 13 are provided with heat dissipation holes 26.

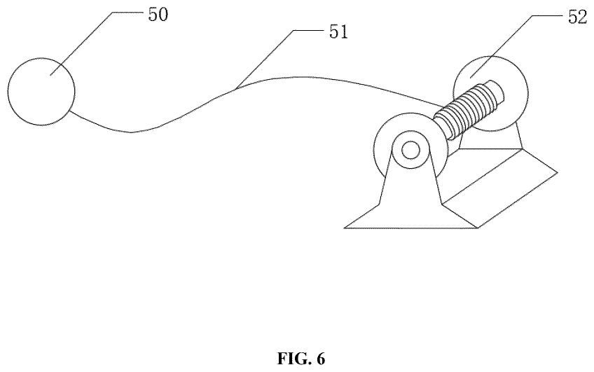

In some embodiments, the low-interference automatic detection device for defects and conditions of drainage pipelines further includes a track installation structure for installing the inspection track 44. As shown in FIG. 6, the track installation structure includes a float ball 50, a float ball cable 51, and a float ball cable storage device 52. A tail end of the float ball 50 is connected to the float ball cable 51. A tail end of the float ball cable 51 is connected to the float ball cable storage device 52.

During the installation of the inspection track 44, one end of the inspection track 44 is connected to the float ball cable 51. The float ball 50 is placed in water of the drainage pipeline through a first inspection well. After the float ball 50 reaches a next inspection well with water flow, the float ball 50 is taken out, and the float ball cable 51 is pulled until the inspection track 44 passes through the drainage pipeline to reach a preset position. Both ends of the inspection track 44 are fixed to the ground and the drainage pipeline.

It should be noted that the inspection track 44 can be installed in a new pipeline that is not laid and an old pipeline that is laid. The inspection track 44 can be directly installed on the new pipeline that is not laid in a factory. During the installation of the inspection track 44 on the old pipeline that is laid, the float ball 50 is placed into the flowing water in the pipeline. The tail end of the float ball 50 is connected to the float ball cable 51. The tail end of the float ball cable 51 is connected to the float ball cable storage device 52. After the float ball 50 reaches the next inspection well after entering the pipeline with water flow, that is, another planned fixation position of the inspection track 44, the float ball 50 is taken out. Since the other end of the float ball cable 51 is connected to one end of the inspection track 44, the float ball cable 51 is pulled to a preset position, and the entire inspection track 44 passes through the pipeline. Then, both ends of the inspection track 44 can be fixed.

For example, the low-interference automatic detection device for defects and conditions of drainage pipelines in the present disclosure can be disposed in a municipal drainage pipeline network and configured to detect defects of drainage pipelines and automatically detect condition information such as liquid levels and sludge levels in the pipeline network.

For a drainage pipeline required to be detected, a pipe section planned to be detected is selected on an old pipeline that is laid. A time period with a flowing condition is selected, the float ball 50 is placed upstream of the drainage pipeline. When the float ball 50 reaches the next inspection well after entering the pipeline with water flow, that is, another planned fixation position of the inspection track 44, the float ball 50 is taken out. The other end of the float ball cable 51 is connected to one end of the inspection track 44, the float ball cable 51 is pulled to a preset position, and the entire inspection track 44 passes through the current pipeline. Then, both ends of the inspection track 44 can be fixed.

The inspection robot carrier 13 is located by identifying the inspection track locator 43 in an automatic routine inspection state and configured to automatically embed the transmission wheels 16 and the engagement plates 17 into the inspection track 44 in a land traveling state and enter the pipeline for inspection. If an inspection starting point is an inspection well covered by one pipeline, the inspection track 44 may not need to be installed above ground. Instead, one end of the inspection track 44 is attached to the side wall of the pipeline, and the transmission wheels 16 and the engagement plates 17 of the inspection robot carrier 13 are manually embedded into the inspection track 44. When the fixed detection system 100 detects potential collapse or deformation of the pipeline, or the condition of the pipeline needs to be inspected, the inspection detection system 200 can be activated.

An operator on the ground issues control commands through the robot controller. The control commands are transmitted via the integrated cable 25 to components such as the video camera 36, the lighting lamp 37, and the high-pressure water jet nozzle 41 on the inspection robot carrier 13, enabling the control of on/off and position adjustment of the video camera 36, the lighting lamp 37, and the high-pressure water jet nozzle 41, and effectively acquiring defects and operational conditions of the pipeline. When the inspection robot carrier 13 needs to be disengaged from the inspection track 44, one method involves returning to a fixed position on the ground track for automatic detachment from the track. Another method involves pulling the withdrawable cabinet latch 29 and disengaging the transmission wheels 16 from the inspection track 44 to complete the inspection.

Through the application of the low-interference automatic detection device for defects and conditions of drainage pipelines in the present disclosure, information such as defects and operational conditions of municipal drainage pipelines is accurately monitored in a real-time manner. This not only addresses the difficulty of pipeline defect identification but also addresses the difficulty of pipeline condition detection under low-interference conditions. This eliminates preparatory tasks such as interception and sludge removal before inspection, significantly reducing the detection cost and improving the detection efficiency. A practical and feasible approach and method are provided for the maintenance of municipal drainage systems.

Based on any one of the foregoing embodiments, an embodiment of the present disclosure proposes an automatic detection method for defects and conditions of drainage pipelines. Two fixed detection systems are a first fixed detection system and a second fixed detection system respectively. The automatic detection method for defects and conditions of drainage pipelines includes the following steps.

In step 1, a plurality of first laser probes of the two fixed detection systems are activated. It is detected whether each first laser probe of the first fixed detection system receives laser emitted by a corresponding first laser probe of the second fixed detection system. It is detected whether each first laser probe of the second fixed detection system receives laser emitted by a corresponding first laser probe of the first fixed detection system.

In step 2, in a case that a first target laser probe in the plurality of first laser probes of the first fixed detection system fails to receive laser emitted by a corresponding first laser probe of the second fixed detection system, position information of a structural defect of the drainage pipeline is acquired based on a laser emission time, laser return time, and laser transmission velocity of the first target laser probe.

In step 3, in a case that a second target laser probe in the plurality of first laser probes of the second fixed detection system fails to receive laser emitted by a corresponding first laser probe of the first fixed detection system, position information of a structural defect of the drainage pipeline is acquired based on a laser emission time, laser return time, and laser transmission speed of the second target laser probe.

In step 4, the inspection detection system is activated when pipeline condition detection needs to be performed. The inspection robot carrier is driven to dock with the inspection track and travel along the inspection track. A first distance from the top of the inspection robot carrier to the top of the drainage pipeline and a second distance from the bottom of the inspection robot carrier to a bottom liquid level or bottom sludge level of the drainage pipeline or the bottom of the pipeline are acquired by the second laser probe at a specified time frequency during the traveling process. Information of a sludge level or liquid level of a corresponding position of the drainage pipeline is acquired based on the first distance, the second distance, and parameters of the drainage pipeline. A position corresponding to position information is detected based on the position information of the structural defect in the drainage pipeline that is acquired by the fixed detection system, so as to determine whether misjudgment occurs at the position.

In the foregoing descriptions of the embodiments, description referring to the term “some embodiments” means that the specific features, structures, materials or characteristics described with reference to the embodiments are included in at least one embodiment of the present disclosure. In this specification, the illustrative expressions of these terms do not necessarily refer to the same embodiment. Moreover, the specific features, structures, materials, or characteristics described may be combined in suitable manners in any one or more embodiments. In addition, without mutual conflict, persons skilled in the art may incorporate and combine different embodiments and features of the different embodiments described in this specification.

In addition, the terms “first” and “second” are merely for the purpose of description, and shall not be understood as any indication or implication of relative importance or any implicit indication of the number of technical features indicated. Therefore, a feature defined by “first” or “second” may explicitly or implicitly include at least one such feature. In the description of the present disclosure, the meaning of “a plurality of” is at least two, for example, two or three, unless otherwise defined explicitly and specifically.

It should be understood that the parts of the present disclosure can be implemented by hardware, software, firmware, or a combination thereof. In the foregoing embodiments, multiple steps or methods may be implemented by software or firmware stored in a memory and executed by a suitable instruction execution system. For example, if implemented by hardware, as in another embodiment, they may be implemented by any one of the following techniques known in the art or by a combination thereof: a discrete logic circuit with a logic gate circuit for implementing the logic function on data signals, an application-specific integrated circuit with a suitable combination of logic gate circuits, a programmable gate array (PGA), a field programmable gate array (FPGA), and the like.

In addition, function units in the embodiments of the present disclosure may be integrated into one processing module, or each of the units may exist alone physically, or two or more units may be integrated into one module. The integrated module may be implemented in a form of hardware, or may be implemented in a form of a software functional module. When the integrated module is implemented in the form of a software functional module and sold or used as an independent product, the integrated module may also be stored in a computer-readable storage medium.

Although the embodiments of the present disclosure have been illustrated and described above. It can be understood that the foregoing embodiments are illustrative and should not be construed as limitations on the present disclosure. Persons of ordinary skill in the art can make changes, modifications, substitutions, and variations to the foregoing embodiments in the scope of the present disclosure.

What is claimed is:

1. A low-interference automatic detection device for defects and conditions of drainage pipelines, comprising an inspection detection system and two fixed detection systems, wherein the fixed detection systems each comprises a semi-arc-shaped pipe wall fixing structure, a fixed detection transmission control system, and a plurality of first laser probes; the fixed detection transmission control system is installed on the pipe wall fixing structure; the plurality of first laser probes are respectively installed at different positions of the pipe wall fixing structure, and the plurality of first laser probes are connected to the fixed detection transmission control system;
the inspection detection system comprises an inspection track and an inspection robot, wherein the inspection robot comprises an inspection robot carrier, a robot controller, a plurality of second laser probes, and a cleaning device; the robot controller is respectively connected to the inspection robot carrier, the plurality of second laser probes, and the cleaning device through an integrated cable; the plurality of second laser probes are respectively installed on a top and bottom of the inspection robot carrier; and the cleaning device is installed on the inspection robot carrier;
the inspection track is configured to pass through a to-be-detected drainage pipeline during detection, the two fixed detection systems are respectively disposed at two ends of the inspection track and located on an upper surface of the inspection track, and the inspection robot carrier is configured to move along a lower surface of the inspection track in a suspended manner;
the two ends of the inspection track are bent upward to form two U-shaped parts, and upper portions of the two U-shaped parts are respectively used as a head end and tail end of the inspection track; the head end and tail end of the inspection track are each provided with an inspection track locator; the inspection robot carrier is configured to locate a docking position and a traveling direction on the inspection track through the inspection track locator; a width of each of the head end and tail end of the inspection track is set to increase from small to large, allowing for smooth docking of the inspection robot carrier onto the inspection track; and
during detection, the inspection track is configured to be fixed to both the ground and a top of the to-be-detected drainage pipeline respectively through an inspection track top fixing rod and an inspection track bottom fixing rod.

2. The low-interference automatic detection device according to claim 1, wherein the pipe wall fixing structure is formed by sequentially connecting a plurality of arc-shaped detection system pipe wall fixing bands; adjacent detection system pipe wall fixing bands are connected through fixing band rotation shafts; each of the plurality of detection system pipe wall fixing bands is provided with a fixing band fastening hole; and the fixed detection transmission control system or the pipe wall fixing structure is provided with a fixed detection system fixing rod for fixing the fixed detection system to the drainage pipeline.

3. The low-interference automatic detection device according to claim 1, wherein the plurality of first laser probes comprise three first laser probes; the three first laser probes are respectively located at two ends and a middle position of the pipe wall fixing structure; and
connection ends of the plurality of first laser probes are each provided with a laser probe rotation shaft; a tail end of the laser probe rotation shaft is provided with a laser probe fixing clasp; the laser probe fixing clasp is rotatable to lock the plurality of first laser probes to corresponding target positions.

4. The low-interference automatic detection device according to claim 1, wherein the inspection robot further comprises four transmission wheels, transmission wheel motors, a withdrawable motor cabinet, inspection positioning detectors, tires, and tire drive motors that are installed on the inspection robot carrier; the four transmission wheels are disposed at the top of the inspection robot carrier, and the four transmission wheels are all driven by the transmission wheel motors; side surfaces of the transmission wheels are concave and are configured to be engaged with the inspection track; two transmission wheel motors corresponding to one side of the inspection track are fixed to the withdrawable motor cabinet through motor bases; a front end of the withdrawable motor cabinet is provided with a withdrawable cabinet latch, and a bottom or side surface of the withdrawable motor cabinet is provided with a snap-fitted structure; the snap-fitted structure is able to be locked with or disengaged from a slot structure on the inspection robot carrier by pulling or pushing the withdrawable cabinet latch; during disengagement, the two transmission wheels on the withdrawable motor cabinet are configured to move along transmission wheel movement grooves on the top of the inspection robot carrier to one side disengaging from the inspection track, achieving the disengagement of the inspection robot carrier from the inspection track; and two tires at a front end of the inspection robot carrier are driven by the tire drive motors.

5. The low-interference automatic detection device according to claim 4, further comprising two U-shaped longitudinal inspection tracks; the two longitudinal inspection tracks are located on inner sides of the two U-shaped parts of the inspection track; both ends of the inspection track are respectively connected to the two longitudinal inspection tracks, and middle portions of the longitudinal inspection tracks are fixed to middle portions of the U-shaped parts through inspection track connecting rods; outer sides of the longitudinal inspection tracks are provided with gear holes;
transmission wheel secondary gears are installed at tops of the transmission wheels; the transmission wheel secondary gears are configured to be engaged with the gear holes of the longitudinal inspection tracks; both sides of the top of the inspection robot carrier are each provided with a semi-enclosed engagement plate; the engagement plate has elasticity; and a side of the engagement plate in contact with the inspection track is provided with an engagement plate planar ball and an engagement plate vertical ball; and
during detection, the longitudinal inspection tracks are fixed to a side wall of a pipeline outlet through longitudinal inspection track fixing rods.

6. The low-interference automatic detection device according to claim 1, wherein the cleaning device comprises a cleaning shovel; a tail end of the cleaning shovel is connected to the inspection robot carrier through a cleaning shovel rotation shaft; a front end of the cleaning shovel is located at the top of the inspection robot carrier and is engaged with the inspection track during inspection; the cleaning shovel is V-shaped; a bent portion of the V-shaped cleaning shovel is wider than both ends of the V-shaped cleaning shovel; upper and lower parts inside the cleaning shovel are respectively provided with a top cleaning sponge and a bottom cleaning sponge; and the front end of the cleaning shovel is provided with a hard rubber shell.

7. The low-interference automatic detection device according to claim 1, wherein the inspection robot further comprises a video camera and a lighting lamp; the video camera is connected to a video camera rotation disk through video camera swing shafts connected to both sides of the video camera; the video camera rotation disk is fixed to a front end of the inspection robot carrier; a lens brush is disposed beside the video camera; the lighting lamp is fixed to the front end of the inspection robot carrier; the robot controller is connected to the video camera and the lighting lamp through the integrated cable; and
the cleaning device comprises a high-pressure water jet nozzle, wherein the high-pressure water jet nozzle is connected to a high-pressure water jet nozzle rotation disk through high-pressure water jet nozzle swing shafts connected to both sides of the high-pressure water jet nozzle, and the high-pressure water jet nozzle rotation disk is fixed to the front end of the inspection robot carrier.

8. The low-interference automatic detection device according to claim 1, further comprising a track installation structure for installing the inspection track; the track installation structure comprises a float ball, a float ball cable, and a float ball cable storage device; a tail end of the float ball is connected to the float ball cable; a tail end of the float ball cable is connected to the float ball cable storage device; and
during the installation of the inspection track, one end of the inspection track is connected to the float ball cable; the float ball is placed in water of the drainage pipeline through a first inspection well; after the float ball reaches a next inspection well with water flow, the float ball is taken out, and the float ball cable is pulled until the inspection track passes through the drainage pipeline to reach a preset position; and both ends of the inspection track are fixed to the ground and the drainage pipeline.
